(19) United States
(12) Patent Application Publication
(10) Pub. No.: US 2026/0126671 A1
(43) Pub. Date: May 7, 2026

(54) HINGE MODULE AND GLASSES

(71) Applicant: GOERTEK INC., Weifang (CN)

(72) Inventors: Haijun YIN, Weifang (CN); Yaocheng LIU, Weifang (CN)

(21) Appl. No.: 19/433,455

(22) Filed: Dec. 26, 2025

Related U.S. Application Data
(63) Continuation of application No. PCT/CN2024/137005, filed on Dec. 5, 2024.

(30) Foreign Application Priority Data
May 31, 2024 (CN) 202410705989.X

(51) Int. Cl. G02C 5/22

(52) U.S. Cl. CPC G02C 5/2263; G02C 5/2254

(57) ABSTRACT

A hinge module and glasses are provided. The hinge module includes a rotating base, a first connecting member, a first elastic member, a second connecting member and a second elastic member. The first connecting member is rotatably connected to the rotating base through a first rotating shaft and a first rotating hole. The first elastic member has a damping groove rotatably abutting against the first rotating shaft, and the other end of the first elastic member elastically abuts against the first connecting member. The second connecting member has a second rotating shaft and a sliding shaft provided at intervals. The second rotating shaft rotatably passes through the second rotating hole to rotatably connect the second connecting member to the rotating base, and the sliding shaft is movably provided in the sliding hole. The second elastic member is accommodated in an accommodating groove and elastically abuts against the sliding shaft.

### CROSS-REFERENCE TO RELATED APPLICATIONS

This application is a continuation application of International Application No. PCT/CN2024/137005, filed on Dec. 5, 2024, which claims priority to Chinese Patent Application No. 202410705989.X, filed on May 31, 2024. The disclosures of the above-mentioned applications are incorporated herein by reference in their entireties.

### TECHNICAL FIELD

The present application relates to the technical field of glasses, and in particular to a hinge module and glasses.

### BACKGROUND

Currently, glasses typically use single-axis rotation to fold the temple for easy storage. However, due to differences in head size, single-axis glasses can cause discomfort and affect user experience. In particular, for virtual reality (VR) glasses, augmented reality (AR) glasses, mixed reality (MR) glasses, and extended reality (XR) glasses, wearing them can even affect the clarity of binocular image display.

In some related art, some glasses have rotating shafts that allow the temples to fold while also having an outward folding function, to accommodate users with different head widths and improve the comfort of the glasses. However, for users with different head lengths, head shapes, and nose-to-ear distances, these single-axis outward flipping glasses can still cause discomfort.

### SUMMARY

The main purpose of the present application is to provide a hinge module and a glasses, specifically a multi-axis rotating hinge module, and the hinge module is applied to glasses. The hinge module allows for multi-degree-of-freedom rotational hinge between the temple and the frame, adapting to different head shapes and improving wearing comfort and versatility.

In order to achieve the above purpose, the present application provides a hinge module, including: a rotating base, a first connecting member, a first elastic member, a second connecting member and a second elastic member;
the rotating base is provided with an accommodating groove and a first rotating hole, a second rotating hole and a sliding hole communicating with the accommodating groove;
the first connecting member is rotatably connected to the rotating base through a first rotating shaft matching with a hole shaft of the first rotating hole;
an end of the first elastic member is accommodated in the accommodating groove and is provided with a damping groove rotatably abutting against the first rotating shaft, and the other end of the first elastic member elastically abuts against the first connecting member;
the second connecting member is provided with a second rotating shaft and a sliding shaft provided at intervals, the second rotating shaft is rotatably provided in the second rotating hole to rotatably connect the second connecting member to the rotating base, and the sliding shaft is movably provided in the sliding hole;
the second elastic member is accommodated in the accommodating groove and elastically abuts against the sliding shaft; and
the axial direction of the first rotating shaft is provided at an angle to the axial direction of the second rotating shaft.

In an embodiment, the rotating base includes a bottom plate and a side plate, the side plate is provided at a periphery edge of the bottom plate and encloses with the bottom plate to form the accommodating groove, the side plate is provided with the first rotating hole, and the bottom plate is provided with the second rotating hole and the sliding hole; and
the side plate is provided with an avoidance notch communicating with the accommodating groove on a side away from the second rotating hole, and an end of the first elastic member away from the second rotating hole passes through the avoidance notch and elastically abuts against the first connecting member.

In an embodiment, the bottom plate is protrudently provided with a rotating cylinder around the second rotating hole, the second rotating shaft rotatably passes through the second rotating hole and rotatably abuts against an inner wall of the rotating cylinder, and the second elastic member is elastically provided between the rotating cylinder and the sliding shaft.

In an embodiment, a plurality of sliding holes are provided, and the plurality of sliding holes are provided at intervals around the second rotating hole; and
the second connecting member is provided with a plurality of sliding shafts, the plurality of sliding shafts are provided at intervals around the second rotating shaft, and each of the plurality of sliding shafts is movably provided in one of the plurality of sliding holes and elastically abuts against the second elastic member.

In an embodiment, the second elastic member includes an arc portion and a first elastic portion and a second elastic portion connected to both ends of the arc portion, an end of the first elastic portion away from the arc portion is bent to form a first bending portion, and the end of the second elastic portion away from the arc portion is bent to form a second bending portion;
the plurality of sliding shafts includes a first sliding shaft corresponding to the arc portion, a second sliding shaft corresponding to the first bending portion, and a third sliding shaft corresponding to the second bending portion; and
the arc portion slidably abuts against an outer wall of the first sliding shaft and elastically abuts against an outer wall of the rotating cylinder, the second sliding shaft movably abuts against the first bending portion, and the third sliding shaft movably abuts against the second bending portion.

In an embodiment, an arc groove is formed on a side of the arc portion facing away from the rotating cylinder, the first bending portion forms a first limiting groove and a first limiting port communicated with the first limiting groove, and the second bending portion forms a second limiting groove and a second limiting port communicated with the second limiting groove;
the hinge module has an initial position, a first position, and a second position where the rotating base drives the first connecting member to rotate relative to the second connecting member around the second rotating shaft;
in the initial position, the first sliding shaft is located within the arc groove, and the second sliding shaft is located at a communicating position of the first limiting groove and the first limiting port, and the third sliding shaft is located at a communicating position of the second limiting groove and the second limiting port;
in the first position, the first sliding shaft slides to a connecting position between the arc portion and the first elastic portion, and the second sliding shaft is located within the first limiting groove, and the third sliding shaft is located at the second limiting port; and
in the second position, the first sliding shaft slides to a connecting position between the arc portion and the second elastic portion, the second sliding shaft is located at the first limiting port, and the third sliding shaft is located within the second limiting groove.

In an embodiment, an axial direction of the second rotating hole is perpendicular to an axial direction of the first rotating hole;
the axial direction of the second rotating hole is parallel to an axial direction of the sliding hole;
an outer wall of the rotating cylinder is provided with a limiting protrusion located between two adjacent sliding holes, the bottom plate is provided with a fixing protrusion corresponding to the limiting protrusion, the limiting protrusion abuts against the fixing protrusion and cooperate with the bottom plate to form a limiting space, and the first elastic portion and the second elastic portion are respectively provided in the limiting space;
the sliding hole is provided in an arc shape with a center of the second rotating hole as a center; and
the second connecting member includes a connecting plate, a second rotating shaft and the sliding shaft protruding from the connecting plate, and the second rotating shaft is further provided with a fixing hole; the second connecting member further includes a fixing member, one end of the fixing member forms a limiting platform, and the second rotating shaft is rotatably provided in the second rotating hole and the rotating cylinder, so that the connecting plate abuts against a side of the bottom plate facing away from the side plate; and an end of the fixing member is provided in the fixing hole, so that the limiting platform movably abuts against the rotating cylinder.

In an embodiment, the first elastic member includes a main body and a damping arm, an end of the main body is accommodated in the accommodating groove, the other end of the main body forms an outward flipping spring sheet, and the outward flipping spring sheet elastically abuts against the first connecting member; and
the main body is further provided with an elastic through hole, an end of the damping arm is connected to an inner wall of the elastic through hole, and the other end of the damping arm extends along the elastic through hole and bends to form the damping groove.

In an embodiment, the first elastic member is made of stainless steel or carbon fiber, and the stainless steel includes one of titanium alloy, nickel-titanium alloy, and beryllium copper;
an elastic module of the first elastic member is 50 GPa to 400 GPa;
a length of the outward flipping spring sheet is 5 mm to 30 mm;
a thickness of the outward flipping spring sheet is 0.3 mm to 1.5 mm;
a distance from an end of the damping arm bent to form the damping groove to the damping arm is provided as an opening width of the damping groove, and the opening width is less than or equal to ⅓ of a circumference of the first rotating shaft;
a fixing post protrudes from a bottom wall of the accommodating groove, the fixing post is located between the first rotating hole and the second rotating hole, and the main body is fixed to the fixing post by a fastener; and
one of the groove wall of the accommodating groove and the main body is provided with a clamping protrusion, the other of the groove wall of the accommodating groove is provided with a clamping groove, and the clamping protrusion is provided in the clamping groove.

In an embodiment, two first rotating holes are provided, and the two first rotating holes are coaxial and located on opposite sides of the accommodating groove;
the first connecting member includes a first connecting portion and two rotating arms provided at both ends of the first connecting portion, the two rotating arms encloses with the first connecting portion to form an avoidance slot, and each of the rotating arms is provided with a mounting hole at an end away from the first connecting portion; and
the first rotating shaft sequentially passes through the mounting hole, the first rotating hole, and the damping groove, and both ends of the first rotating shaft are fixed in the two mounting holes, so that a portion of the rotating base is accommodated in the avoidance slot, and an end of the first elastic member away from the second rotating hole elastically abuts against the first connecting portion.

In an embodiment, the first rotating shaft includes a rotating shaft portion and mounting portions connected to both ends of the rotating shaft portion, the rotating shaft portion sequentially passes through the first rotating hole and the damping groove, each of the mounting portions is provided in a mounting hole, the mounting hole is provided with at least one mounting plane, and the mounting portion is provided with a limiting plane matching with the mounting plane;
the mounting hole is a polygonal hole, and the first rotating hole is a circular hole;
the mounting hole is a polygonal hole, and the first rotating hole is a circular hole;
the first connecting portion is recessed to form a position avoiding groove communicating with the avoidance slot, a support platform protrudes from a side of the position avoiding groove adjacent to the avoidance slot, and an end of the first elastic member away from the second rotating hole extends into the position avoiding groove and is elastically supported on the support platform; and
the first connecting member further includes a limiting portion, both ends of the limiting portion are respectively connected to an end of the two rotating arms away from the first connecting portion, and the limiting portion is located on a side of the first elastic member away from the accommodating groove.

In an embodiment, the hinge module further includes: a protective plate and a housing;
the protective plate is accommodated in the accommodating groove and connected to a side of the first elastic member facing away from a bottom wall of the accommodating groove; and
a side of the protective plate facing away from the first elastic member is provided with a wire passage groove, and the housing covers an opening of the accommodating groove and cooperates with the wire passing groove to form a wire passage.

The present application further includes: a frame, a temple and the hinge module described above; and
the second connecting member of the hinge module is connected to the frame, and the first connecting member of the hinge module is connected to the temple

The hinge module of the present application has an accommodating groove on a rotating base and a first rotating hole, a second rotating hole, and a sliding hole communicating with the accommodating groove. A first connecting member is rotatably connected to the rotating base through a first rotating shaft matching with the hole shaft of the first rotating hole. A second rotating shaft of the second connecting member second rotating shaft is rotatably provided in the second rotating hole, and a sliding shaft is movably provided in the sliding hole. This allows the second connecting member to be rotatably connected to the rotating base, and the axial direction of the first rotating shaft is provided at an angle to the second rotating shaft, enabling the hinge module to achieve multi-axis rotation. That is, the hinge module can rotate relative to the rotating base through the first connecting member around the first rotating shaft, and simultaneously rotate relative to the second connecting member through the rotating base around the second rotating shaft, achieving multi-degree-of-freedom rotation. When the hinge module is applied to glasses, the temples of the glasses are connected to the frame through the hinge module, allowing the temples to rotate relative to the rotating base and the frame through the first connecting member around the first rotating shaft. Meanwhile, the temples can also rotate relative to the frame through the rotating base around the second rotating shaft. This means the temples and frame can achieve multi-degree-of-freedom rotational hinges through a multi-axis hinge structure, making the glasses suitable for different head shapes, such as different head lengths, head shapes, and nose-ear distances, thus improving user comfort and versatility. Simultaneously, by placing one end of the first elastic member in the accommodating groove and providing a damping groove on the first elastic member that abuts against the first rotating shaft, the other end of the first elastic member elastically abuts against the first connecting member. Thus, when the first connecting member of the hinge module rotates relative to the rotating base around the first rotating shaft, the first elastic member provides damping function for the rotation of the first connecting member. The second elastic member is accommodated in the accommodating groove and elastically abuts against the sliding shaft. In this way, the second elastic member providing elastic limiting function and damping function for the rotation of the rotating base relative to the second connecting member, thereby providing different rotation angles.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only portion of embodiments of the present application. For those skilled in the art, other drawings can also be obtained according to the structures shown in these drawings without any creative effort.

FIG. 1 is a schematic structural view of a hinge module according to an embodiment of the present application.

FIG. 2 is an exploded schematic view of the hinge module according to an embodiment of the present application.

FIG. 3 is a schematic structural view of a rotating base of the hinge module according to an embodiment of the present application.

FIG. 4 is a schematic structural view of a first connecting member of the hinge module according to an embodiment of the present application.

FIG. 5 is a schematic structural view of a first elastic member of the hinge module according to an embodiment of the present application.

FIG. 6 is a schematic structural view of a second connecting member of the hinge module according to an embodiment of the present application.

FIG. 7 is a schematic structural view of a second elastic member of the hinge module according to an embodiment of the present application.

FIG. 8 is a schematic structural view of glasses according to an embodiment of the present application.

FIG. 9 is an exploded schematic view of the glasses according to an embodiment of the present application.

FIG. 10 is a cross-sectional schematic view along an axial direction of a second rotating shaft of rotation of the glasses according to an embodiment of the present application.

FIG. 11 is a cross-sectional schematic view along an axial direction of a first rotating shaft of rotation of the glasses according to an embodiment of the present application.

FIG. 12 is a cross-sectional schematic view in FIG. 11 at a second position.

FIG. 13 is a schematic structural view of a temple rotating around the second rotating shaft of the glasses according to an embodiment of the present application.

FIG. 14 is a schematic structural view of the temple rotating around the first rotating shaft of the glasses according to an embodiment of the present application.

The objectives, functional features, and advantages of the present application will be further explained in combination with the embodiments and with reference to the accompanying drawings.

### DETAILED DESCRIPTION OF THE EMBODIMENTS

The technical solutions of the embodiments of the present application will be clearly and completely described below with reference to the accompanying drawings. Obviously, the described embodiments are only a portion of the embodiments of the present application, and not all of the embodiments. Based on the embodiments of the present application, all other embodiments obtained by those skill in the art without creative effort are within the scope of protection of the present application.

It should be noted that all directional indicators (such as up, down, left, right, front, back, etc.) in the embodiments of the present application are only used to explain the relative positional relationship and movement of each component in a certain specific posture (as shown in the drawings). If the specific posture changes, the directional indicator will also change accordingly.

Meanwhile, the meaning of “and/or” appearing in the present application includes three parallel scenarios. For example, “A and/or B” includes only A, or only B, or both A and B.

Furthermore, the use of terms such as “first” and “second” in the present application is for descriptive purposes only and should not be construed as indicating or implying their relative importance or implicitly specifying the number of technical features indicated. Therefore, a feature defined as “first” or “second” may explicitly or implicitly include at least one of those features. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of the present application.

Currently, glasses typically use single-axis rotation to fold the temple for easy storage. However, due to differences in head size, single-axis glasses can cause discomfort and affect user experience. In particular, for virtual reality (VR) glasses, augmented reality (AR) glasses, mixed reality (MR) glasses, and extended reality (XR) glasses, wearing them can even affect the clarity of binocular image display.

In related art, some glasses have rotating shafts that allow the temples to fold while also having an outward folding function, to accommodate users with different head widths and improve the comfort of the glasses. However, for users with different head lengths, head shapes, and nose-to-ear distances, these single-axis outward flipping glasses can still cause discomfort.

Meanwhile, in order to achieve multi-axis rotation, the temples and the frame of glasses usually employ a plurality of single-axis structures to achieve rotation on different axes. This results in a complex and dispersed hinge structure, a large structural volume, and a bulky overall structure, making disassembly quite complicated.

Based on the above concepts and problems, the present application provides a hinge module 100, and the hinge module 100 can be applied to glasses 800. The glasses 800 can be myopia glasses, presbyopia glasses, astigmatism glasses, sun protection glasses, and decorative glasses that people wear regularly. The glasses 800 can also be smart glasses, such as virtual reality (VR) glasses, augmented reality (AR) glasses, mixed reality (MR) glasses, and extended reality (XR) glasses, etc., without limitation.

In this embodiment, the glasses 800 includes a frame 810 and a temple 820, and the temple 820 is connected to the frame 810 through a hinge module 100. The hinge module 100 is an integrated hinge structure that enables the hinged connection between the frame 810 and the temple 820, while also facilitating overall assembly and disassembly. It can be understood that the temple 820 of the glasses 800 is connected to the frame 810 through the hinge module 100, enabling the glasses 800 not only to achieve the functions of folding and storing, normal wearing, and outward flipping of the temple 820 relative to the frame 810, but also to allow the rotational adjustment of the temple 820 relative to the frame 810 in another direction. This makes the glasses 800 suitable for users with different head lengths, head shapes, and nose-ear distances, improving user comfort and versatility.

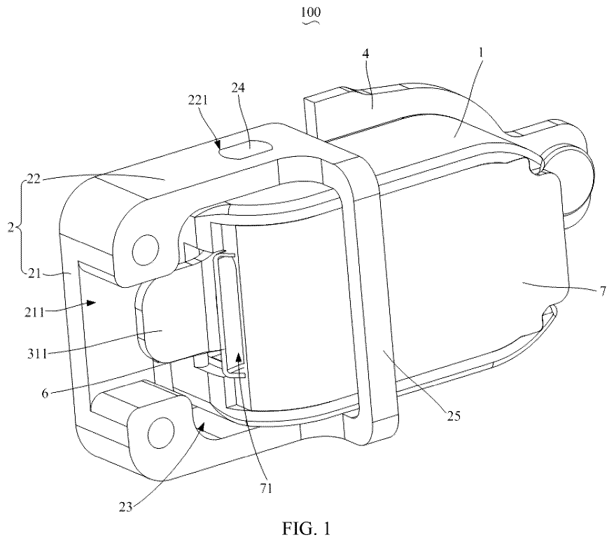

Referring to FIG. 1 to FIG. 7, in this embodiment of the present application, the hinge module 100 includes a rotating base 1, a first connecting member 2, a first elastic member 3, a second connecting member 4 and a second elastic member 5. The rotating base 1 is provided with an accommodating groove 11 and a first rotating hole 131, a second rotating hole 121, and a sliding hole 122 communicating with the accommodating groove 11. The first connecting member 2 is rotatably connected to the rotating base 1 through a first rotating shaft 24 matching with the hole shaft of the first rotating hole 131. One end of the first elastic member 3 is provided in the accommodating groove 11 and is provided with a damping groove abutting against the first rotating shaft 24, and the other end of the first elastic member 3 elastically abuts against the first connecting member 2. The second connecting member 4 is provided with a second rotating shaft 41 and a sliding shaft 42 provided at intervals, and the second rotating shaft 41 is rotatably provided in the second rotating hole 121 so that the second connecting member 4 is rotatably connected to the rotating base 1. The sliding shaft 42 is movably provided in the sliding hole 122, and the second elastic member 5 is accommodated in the accommodating groove 11 and elastically abuts against the sliding shaft 42. The axial direction of the first rotating shaft 24 is provided at an angle to the axial direction of the second rotating shaft 41.

In this embodiment, the hinge module 100 is configured as a rotating base 1, a first connecting member 2 and a second connecting member 4. The rotating base 1 is provided with an accommodating groove 11 and a first rotating hole 131, a second rotating hole 121, and a sliding hole 122 communicating with the accommodating groove 11. One end of the first connecting member 2 is rotatably connected to the rotating base 1 through a first rotating shaft 24 matching with the hole shaft of the first rotating hole 131, and the other end of the first connecting member 2 can be configured to be connected to the temple 820. That is, the temple 820 is rotatably connected to the rotating base 1 through the first connecting member 2 and the first rotating shaft 24. The second rotating shaft 41 of the second connecting member 4 is rotatably provided in the second rotating hole 121, and the sliding shaft 42 is movably provided in the sliding hole 122, so that the rotating base 1 is rotatably connected to the second connecting member 4. The second connecting member 4 is configured to be connected to the frame 810. In this way, the temple 820 is rotatably connected to the frame 810 through the hinge module 100.

It should be noted that since the axial direction of the first rotating shaft 24 is provided at an angle to the axial direction of the second rotating shaft 41, that is, the first connecting member 2 of the hinge module 100 rotates relative to the rotating base 1 around the axial direction of the first rotating shaft 24, and the rotating base 1 rotates relative to the second connecting member 4 around the axial direction of the second rotating shaft 41, thereby enabling the hinge module 100 to rotate with a plurality of degrees of freedom in a plurality of axial directions. In this way, the hinge module 100 is applied to the glasses 800, so that the glasses 800 can be worn by users with different head lengths, different head shapes, and different nose-ear distances, improving the user's wearing comfort and versatility. That is, the temple 820 rotates relative to the rotating base 1 and the frame 810 through the first connecting member 2 around the axial direction of the first rotating shaft 24, and the temple 820 rotates relative to the frame 810 through the rotating base 1 around the axial direction of the second rotating shaft 41, thereby enabling the temple 820 to rotate with a plurality of degrees of freedom relative to the frame 810 in a plurality of axial directions.

In this embodiment, by accommodating one end of the first elastic member 3 in the accommodating groove 11, providing a damping groove 321 on the first elastic member 3 that rotatably abuts against the first rotating shaft 24, and elastically abutting the other end of the first elastic member 3 against the first connecting member 2, the hinge module 100 utilizes the frictional damping generated by the first elastic member 3 during the rotation of the first connecting member 2 around the axial direction of the first rotating shaft 24 relative to the rotating base 1. This results in a hinge movement with a damped folding feel during the movement of the first connecting member 2, thereby achieving the folding of the temple 820 and providing a damped folding feel and a clamping force for outward folding. Meanwhile, by providing the second elastic member 5 in the accommodating groove 11 and elastically abutting against the sliding shaft 42, the second elastic member 5 provides resistance to deformation and prevents over-bending failure during the rotation of the hinge module 100 relative to the second connecting member 4 through the axial direction of the second rotating shaft 41 of the rotating base 1.

The hinge module 100 of the present application has an accommodating groove 11 on the rotating base 1 and a first rotating hole 131, a second rotating hole 121 and a sliding hole 122 communicating with the accommodating groove 11. In this way, the first connecting member 2 is rotatably connected to the rotating base 1 by the first rotating shaft 24 matching with the hole shaft of the first rotating hole 131, a second rotating shaft 41 of the second connecting member 4 is rotatably provided in the second rotating hole 121, and a sliding shaft 42 is movably provided in the sliding hole 122. In this way, the second connecting member 4 is rotatably connected to the rotating base 1, and the axial direction of the first rotating shaft 24 is provided at an angle to the axial direction of the second rotating shaft 24, thereby enabling the hinge module 100 to achieve multi-axis rotation. In this embodiment, the axial direction of the first rotating shaft 24 is perpendicular to the axial direction of the second rotating shaft 41. It can be understood that, with the user wearing glasses 800 and the user's eyes as the reference for the light output direction, the light emission direction, the axial direction of the first rotating shaft 24 and the axial direction of the second rotating shaft 41 are approximately perpendicular to each other in a three-dimensional coordinate structure. That is, the axial direction of the first rotating shaft 24 and the axial direction of the second rotating shaft 41 are both approximately perpendicular to the light emission direction, and the axial direction of the second rotating shaft 41 is provided approximately perpendicular to the light emission direction.

It should be noted that when the hinge module 100 is applied to the glasses 800, referring to FIG. 14, the glasses 800 has a folded state, an open state, and an outward flipping state, where the temple 820 rotates relative to the rotating base 1 and the frame 810 through the first connecting member 2 around the first rotating shaft 24. It can be understood that when the glasses 800 is folded, the temple 820 are close to the frame 810, meaning the temple 820 is provided approximately parallel to the frame 810, making the glasses 800 easy to store when folded. When the glasses 800 is in the open position, the two temples 820 are provided approximately perpendicular to the frame 810. At this time, the two temples 820 and the frame 810 approximately form a U-shaped wearing cavity, facilitating supporting and abutting against of the two temples 820 with the user's ears. Meanwhile, the nose pad of the frame 810 abuts against the user's nose bridge, thereby realizing the wearing function. When the glasses 800 is in the outward flipping state, the two temples 820 are provided approximately at an obtuse angle to the frame 810. At this time, the two temples 820 approximately encloses with the frame 810 to form a U-shaped wearing cavity with flared opening. The two temples 820 support and abut against the user's ear, and the nose pad of the frame 810 abut against the user's nose bridge, thereby realizing the wearing function. That is, the outward flipping state is suitable for users with wider heads, while the open state is suitable for users with narrower heads.

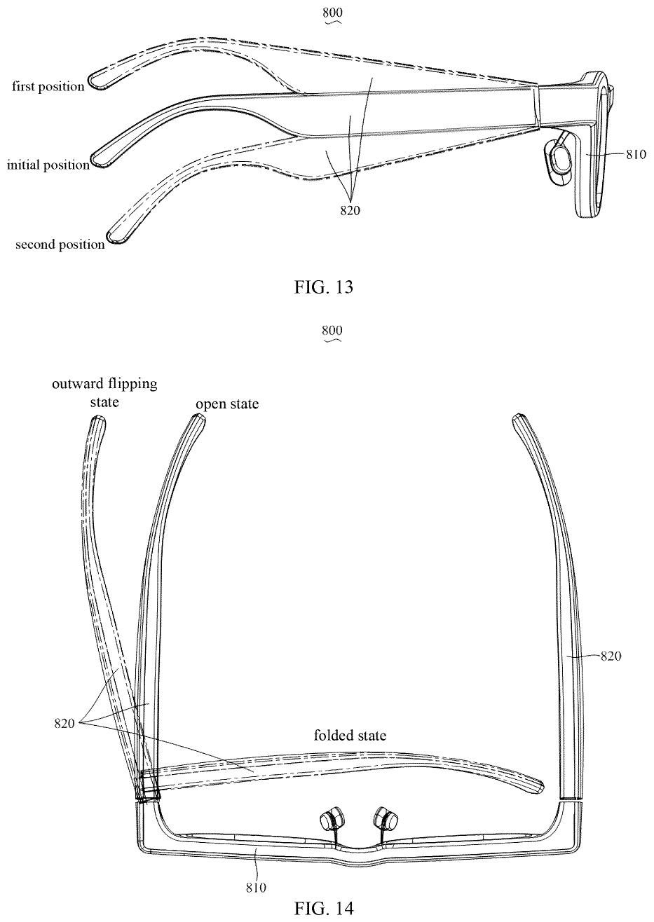

Meanwhile, as shown in FIG. 13, the glasses 800 has an initial position, a first position, and a second position, where the temples 820 rotate relative to the frame 810 through the rotating base 1 around the second rotating shaft 41. In this embodiment, the rotation of the temple 820 relative to the frame 810 around the second rotating shaft 41 can be performed when the glasses 800 is in the open state and the outward flipping state. That is, when the glasses 800 is in the open state and the outward flipping state, the temples 820 can rotate relative to the frame 810 around the second rotating shaft 41 in the initial position, the first position, and the second position, thus making it suitable for users with different head lengths and different nose-ear distances.

It should be noted that when the glasses 800 is in the open state, and the temples 820 are in their initial position, the extension direction of the temples 820 is consistent with the extension direction of the connecting portion or mounting portion of the frame 810. When the temples 820 are in the first position or the second position, the extension direction of the temples 820 forms a certain angle with the extension direction of the connecting portion or mounting portion of the frame 810. In an embodiment, the angle formed by the extension direction of the temples 820 and the extension direction of the connecting or mounting portion of the frame 810 is an acute angle.

It can be understood that, taking the plane where the light output direction of the user's two eyes is located when the user wears glasses 800 as the horizontal plane, with glasses 800 in the open state and the outward flipping state, when the temple 820 is in the first position, the end of the temple 820 away from the frame 810 is above this horizontal plane, and the angle formed by the extension direction of the temple 820 and the horizontal plane is an acute angle. When the temple 820 is in the second position, the end of the temple 820 away from the frame 810 is below this horizontal plane, and the angle formed by the extension direction of the temple 820 and the horizontal plane is an acute angle.

In an embodiment, the rotating base 1 includes a bottom plate 12 and a side plate 13, and the side plate 13 is provided at the periphery edge of the bottom plate 12 and encloses with the bottom plate 12 to form an accommodating groove 11. The side plate 13 is provided with a first rotating hole 131, and the bottom plate 12 is provided with a second rotating hole 121 and a sliding hole 122. An avoidance notch 132 communicating with the accommodating groove 11 is provided at the side of the side plate 13 away from the second rotating hole 121. The end of the first elastic member 3 away from the second rotating hole 121 passes through the avoidance notch 132 and elastically abuts against the first connecting member 2.

In this embodiment, as shown in FIG. 1 to FIG. 3 and FIG. 10 to FIG. 12, the side plate 13 of the rotating base 1 is provided around the periphery edge of the bottom plate 12. The side plate 13 is perpendicular to the bottom plate 12, so that the side plate 13 encloses with the bottom plate 12 to form an accommodating groove 11. In an embodiment, the bottom plate 12 is configured in rectangular or elongated shape. By providing an avoidance notch 132 at one end of the side plate 13 adjacent to the bottom plate 12, the avoidance notch 132 can be configured to provide avoidance and limiting space for the first elastic member 3, so that one end of the first elastic member 3 passes through the avoidance notch 132 and elastically abuts against the first connecting member 2.

It can be understood that the side plate 13 is further provided with a first rotating hole 131, and the first rotating hole 131 is located at an end of the side plate 13 adjacent to the avoidance notch 132. In an embodiment, the axial direction of the second rotating hole 121 is perpendicular to the axial direction of the first rotating hole 131. This makes the axial direction of the second rotating hole 121 be perpendicular to the axial direction of the first rotating hole 131.

In this embodiment, in order to prevent the second rotating shaft 41 from affecting the first connecting member 2 in driving the temple 820 to rotate around the first rotating shaft 24, the bottom plate 12 is provided with a second rotating hole 121 and a sliding hole 122 provided at intervals, and the second rotating hole 121 is located at the end of the bottom plate 12 away from the avoidance notch 132. It can be understood that one end of the rotating base 1 is rotatably connected to the second connecting member 4, and the other end of the rotating base 1 is rotatably connected to the first connecting member 2.

In order to ensure that the rotating base 1 can rotate relative to the second connecting member 4 around the second rotating shaft 41, in an embodiment, the bottom plate 12 is protrudingly provided with a rotating cylinder 125 around the second rotating hole 121. The second rotating shaft 41 rotatably passes through the second rotating hole 121 and rotatably abuts against the inner wall of the rotating cylinder 125. The second elastic member 5 is elastically provided between the rotating cylinder 125 and the sliding shaft 42.

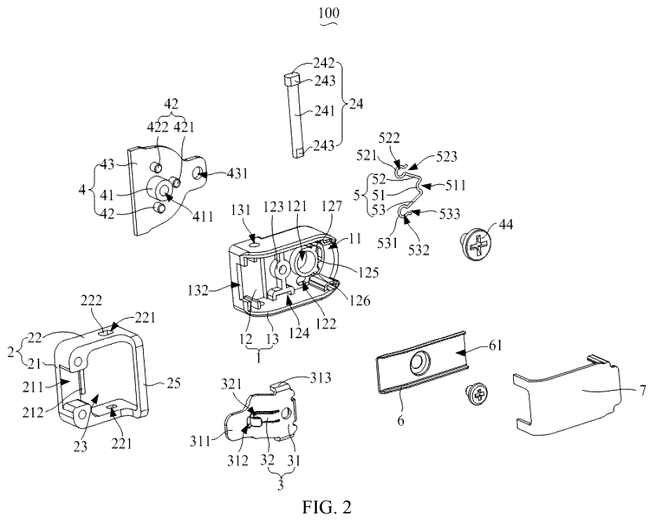

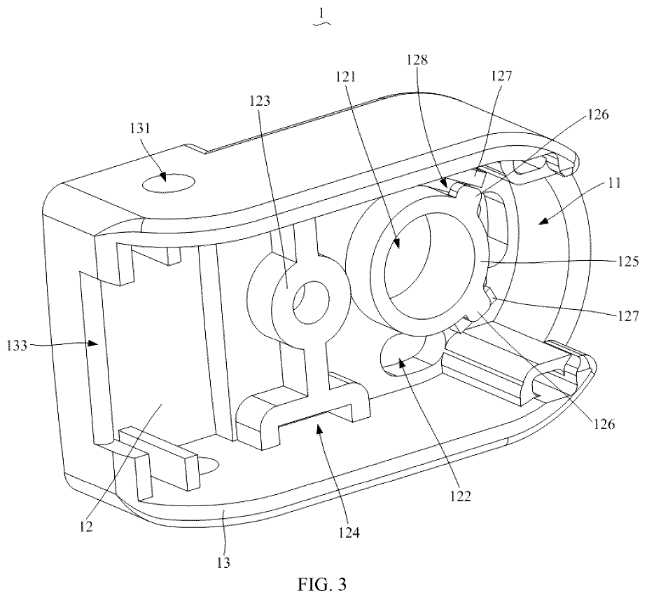

It can be understood that, as shown in FIG. 2 and FIG. 3, by protrudingly providing a rotating cylinder 125 on the bottom plate 12 of the rotating base 1, the rotating cylinder 125 is provided around the second rotating hole 121. In this way, the second rotating shaft 41 is rotatably provided in the second rotating hole 121 and rotatably abuts against the inner wall of the rotating cylinder 125, thereby using the rotating cylinder 125 to provide rotation and limiting space for the second rotating shaft 41.

In an embodiment, a plurality of sliding hole 122 are provided, and the plurality of sliding holes 122 provided at intervals around the second rotating hole 121. The second connecting member 4 is protrudingly provided with a plurality of sliding shafts 42, and the plurality of sliding shafts 42 are provided at intervals around the second rotating shaft 41. Each of the plurality of sliding shaft 42 is movably provided in a sliding hole 122 and elastically abuts against the second elastic member 5.

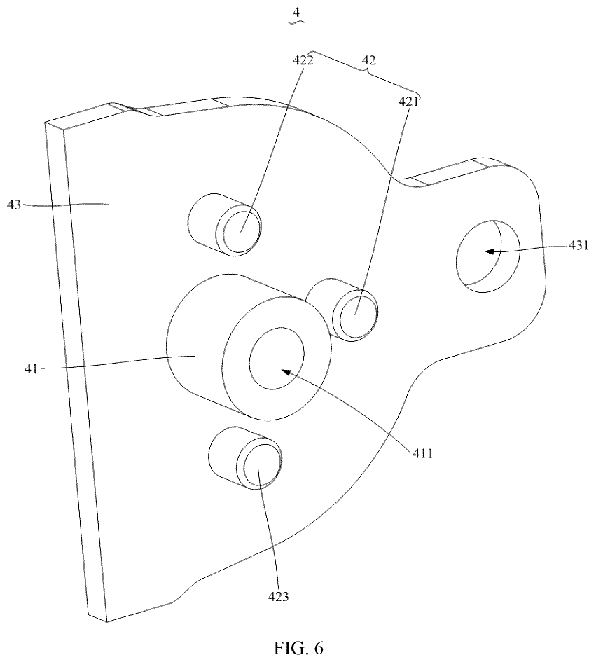

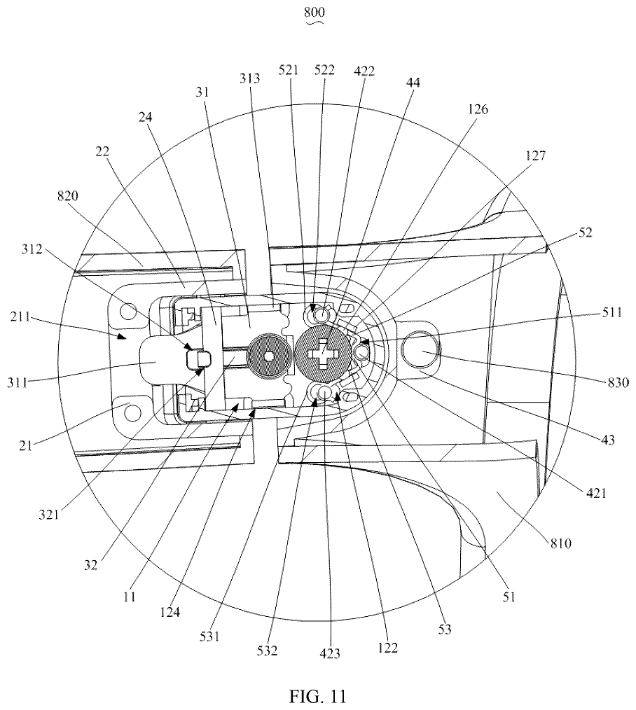

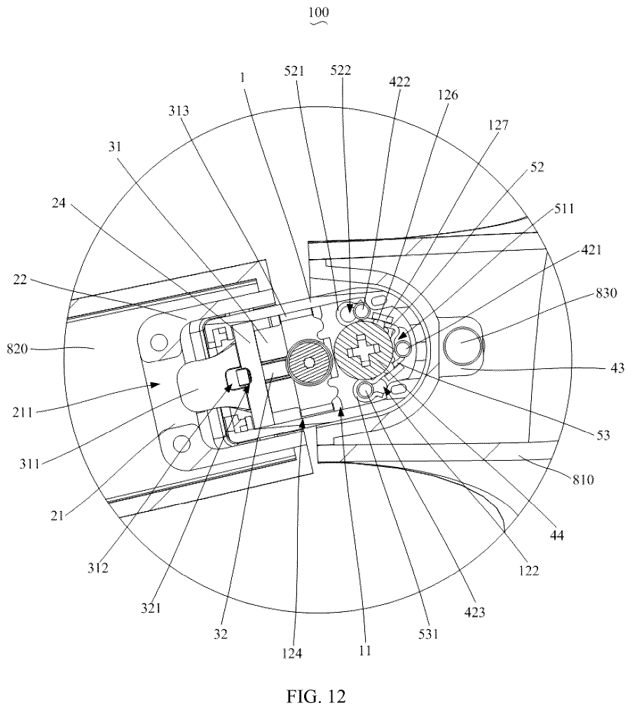

In this embodiment, as shown in FIG. 2, FIG. 3, FIG. 6, FIG. 11, and FIG. 12, the number of sliding shafts 42 is consistent with the number of sliding holes 122 and the number of second rotating holes 121, and they are provided in a one-to-one correspondence. In an embodiment, the axial direction of the second rotating hole 121 is parallel to the axial direction of the sliding hole 122.

In order to facilitate the movement of the sliding shaft 42 around the sliding hole 122 when the rotating base 1 rotates around the second rotating shaft 41. In an embodiment, the sliding hole 122 is provided in an arc shape with the center of the second rotating hole 121 as the center. In this embodiment, as shown in FIG. 2, FIG. 3, FIG. 6, FIG. 11, and FIG. 12, three sliding holes 122 and three sliding shafts 42 are provided, and the three sliding holes 122 are provided at intervals around the second rotating hole 121. In an embodiment, the line connecting of the three sliding holes 122 is provided in a semi-circular arc shape.

In an embodiment, the second elastic member 5 includes an arc portion 51 and a first elastic portion 52 and a second elastic portion 53 connected to both ends of the arc portion 51. The end of the first elastic portion 52 away from the arc portion 51 is bent to form a first bending portion 521, and the end of the second elastic portion 53 away from the arc portion 51 is bent to form a second bending portion 531. The plurality of sliding shafts 42 include a first sliding shaft 421 corresponding to the arc portion 51, a second sliding shaft 422 corresponding to the first bending portion 521, and a third sliding shaft 423 corresponding to the second bending portion 531. The arc portion 51 slidably abuts against the outer wall of the first sliding shaft 421 and elastically abuts against the outer wall of the rotating cylinder 125. The second sliding shaft 422 movably abuts against the first bending portion 521, and the third sliding shaft 423 movably abuts against the second bending portion 531.

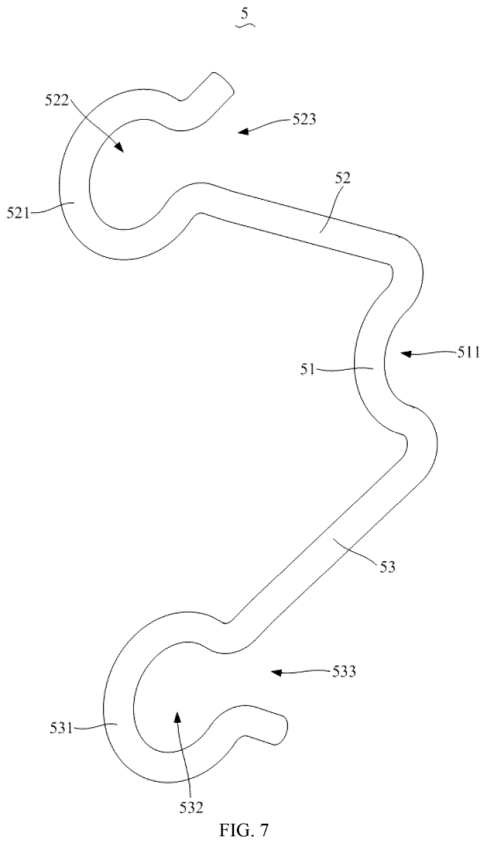

In this embodiment, as shown in FIG. 2, FIG. 7, FIG. 11, and FIG. 12, by providing the second elastic member 5 as an arc portion 51 and a first elastic portion 52 and a second elastic portion 53 connected to both ends of the arc portion 51, the arc portion 51 of the second elastic member 5 is elastically provided between the outer wall of the first sliding shaft 421 and the outer wall of the rotating cylinder 125, the first bending portion 521 of the first elastic portion 52 elastically abuts against the second sliding shaft 422, and the second bending portion 531 of the second elastic portion 53 elastically abuts against the third sliding shaft 423. In this way, the second elastic member 5, with the cooperation of the arc portion 51, the first bending portion 521 of the first elastic portion 52, and the second bending portion 531 of the second elastic portion 53, enables the rotating base 1 of the hinge module 100 to drive the first connecting member 2 to rotate around the second rotating shaft 41 at different angles.

It can be understood that the first elastic portion 52 and the second elastic portion 53 are connected to both ends of the arc portion 51. In an embodiment, the material of the second elastic member 5 can be a metal material, such as stainless steel, which includes materials such as titanium alloy, nickel-titanium alloy, and beryllium copper; or, the material of the second elastic member 5 can also be a non-metallic material, such as elastic plastic or carbon fiber, etc., which is not limited here.

In this embodiment, the first elastic portion 52, the arc portion 51 and the second elastic portion 53 of the second elastic member 5 are integrally formed. The first elastic portion 52, the arc portion 51, and the second elastic portion 53 of the second elastic member 5 roughly enclose to form a V-shaped structure.

In order to further limit the first elastic portion 52 and the second elastic portion 53 of the second elastic member 5, and to prevent the second elastic member 5 from shifting due to deformation during the rotation of the first connecting member 2 around the second rotating shaft 41 driven by the rotating base 1. In an embodiment, a limiting protrusion 126 protruding from the outer wall of the rotating cylinder 125 is located between two adjacent sliding holes 122, and the bottom plate 12 is provided with a fixing protrusion 127 corresponding to the limiting protrusion 126. The limiting protrusion 126 abuts against the fixing protrusion 127 and cooperates with the bottom plate 12 to form a limiting space 128, and the first elastic portion 52 and the second elastic portion 53 are respectively provided in the limiting space 128.

In this embodiment, as shown in FIG. 2, FIG. 3, FIG. 11 and FIG. 12, a limiting protrusion 126 and a fixing protrusion 127 are respectively provided at the outer wall of the rotating cylinder 125 and the bottom plate 12 of the rotating base 1, so that the limiting protrusion 126 abuts against the fixing protrusion 127 and cooperates with the bottom plate 12 to form a limiting space 128. The limiting space 128 is located between two adjacent sliding holes 122, thereby facilitating the use of the limiting space 128 to limit the first elastic portion 52 and the second elastic portion 53.

In an embodiment, the arc portion 51 forms an arc groove 511 on the side facing away from the rotating cylinder 125, the first bending portion 521 forms a first limiting groove 522 and a first limiting port 523 communicated with the first limiting groove 522, and the second bending portion 531 forms a second limiting groove 532 and a second limiting port 533 communicated with the second limiting groove 532. The hinge module 100 has an initial position, a first position and a second position, where the rotating base 1 drives the first connecting member 2 to rotate relative to the second connecting member 4 around the second rotating shaft 41. In the initial position, the first sliding shaft 421 is located in the arc groove 511 and the second sliding shaft 422 is located at the communicating position between the first limiting groove 522 and the first limiting port 523, the third sliding shaft 423 is located at the communicating position of the second limiting groove 532 and the second limiting port 533; in the first position, the first sliding shaft 421 slides to the connecting position of the arc portion 51 and the first elastic portion 52, the second sliding shaft 422 is located in the first limiting groove 522, and the third sliding shaft 423 is located at the second limiting port 533; in the second position, the first sliding shaft 421 slides to the connecting position of the arc portion 51 and the second elastic portion 53, and the second sliding shaft 422 is located at the first limiting port 523, and the third sliding shaft 423 is located in the second limiting groove 532.

In this embodiment, as shown in FIG. 2, FIG. 7, FIG. 11 and FIG. 12, by providing an arc groove 51 at the arc portion 51, providing a first limiting groove 522 and a first limiting port 523 at the first bending portion 521, and providing a second limiting groove 532 and a second limiting port 533 at the second bending portion 531, the limiting structure at the connection between the first limiting groove 522 and the first limiting port 523 is configured to achieve adjustment of different gears.

It can be understood that the first limiting port 523 formed by the first bending portion 521 gradually increases in size from the communicating position between the first limiting groove 522 and the first limiting port 523 to a point away from the communicating position, that is, the first limiting port 523 is provided with a flared opening. This facilitates the cooperation between the first limiting port 523 and the second sliding shaft 422, and compresses the second sliding shaft 422 into the first limiting groove 522 from the connection between the first limiting groove 522 and the first limiting port 523. The second limiting port 533 formed by the second bending portion 531 gradually increases in size from the communicating position between the second limiting groove 532 and the second limiting port 533 to a point away from the communicating position, that is, the second limiting port 533 is provided with a flared opening. This facilitates the cooperation between the second limiting port 533 and the third sliding shaft 423, and compresses the third sliding shaft 423 into the second limiting groove 532 from the communicating position between the second limiting groove 532 and the second limiting port 533.

In an embodiment, the shape and contour of the first limiting groove 522 are similar to the shape and contour of the second sliding shaft 422. The shape and contour of the second limiting groove 532 are similar to shape and contour of the third sliding shaft 423.

It can be understood that the rotating base 1 drives the first connecting member 2 to rotate relative to the second connecting member 4 around the second rotating shaft 41, so that the first connecting member 2 and the rotating base 1 have an initial position, a first position, and a second position. In this embodiment, in the initial position, the first sliding shaft 421 is located in the arc groove 511, and the second sliding shaft 422 is located at the communicating position between the first limiting groove 522 and the first limiting port 523, and the third sliding shaft 423 is located at the communicating position between the second limiting groove 532 and the second limiting port 533; in the first position, the first sliding shaft 421 slides to the connecting position between the arc portion 51 and the first elastic portion 52, the second sliding shaft 422 is located in the first limiting groove 522, and the third sliding shaft 423 is located at the second limiting port 533; in the second position, the first sliding shaft 421 slides to the connection between the arc portion 51 and the second elastic portion 53, the second sliding shaft 422 is located at the first limiting port 523, and the third sliding shaft 423 is located in the second limiting groove 532.

In an embodiment, the arc groove 511 has a semi-circular groove structure. The connection between the arc portion 51 and the first elastic portion 52 and the second elastic portion 53 forms two limiting points on both sides of the arc groove 511. The communicating position between the first limiting groove 522 formed by the first bending portion 521 and the first limiting port 523 is the first limiting position, and the communicating position between the second limiting groove 532 formed by the second bending portion 531 and the second limiting port 533 is the second limiting position. It can be understood that when the first connecting member 2 and the rotating base 1 of the hinge module 100 are in the initial position, the first sliding shaft 421 is located in the arc groove 511, the second sliding shaft 422 is located at the first limit position, and the third sliding shaft 423 is located at the second limit position. When the rotating base 1 drives the first connecting member 2 to rotate relative to the second connecting member 4 around the second rotating shaft 41, causing the first connecting member 2 and the rotating base 1 of the hinge module 100 to move from the initial position to the first position, the first sliding shaft 421 located in the arc groove 511 moves to the limit point of the arc groove 511 close to the second elastic portion 53. At this time, the second sliding shaft 422 is located in the first limiting groove 522, and the third sliding shaft 423 is located at the second limiting port 533. When the rotating base 1 drives the first connecting member 2 to rotate around the second rotating shaft 41 relative to the second connecting member 4, causing the first connecting member 2 and the rotating base 1 of the hinge module 100 to move from the initial position to the second position, the first sliding shaft 421 located in the arc groove 511 moves to the limiting point of the arc groove 511 close to the first elastic portion 52. At this time, the second sliding shaft 422 is located at the first limiting port 523, and the third sliding shaft 423 is located in the second limiting groove 532.

It should be noted that when the hinge module 100 is in the open state or outward flipping state, the first connecting member 2 of the hinge module 100 has an initial position, a first position, and a second position where the rotating base 1 drives the first connecting member 2 to rotate relative to the second connecting member 4 around the second rotating shaft 41. When the hinge module 100 is applied to the glasses 800, the glasses 800 is in the open state or outward flipping state, the temples 820 of the glasses 800 have an initial position, a first position, and a second position where the rotating base 1 drives the first connecting member 2 and the temples 820 to rotate relative to the frame 810 around the second rotating shaft 41. When the temples 820 are in the initial position, the first sliding shaft 421 is located in the arc groove 511, the second sliding shaft 422 is located at the first limit position, and the third sliding shaft 423 is located at the second limit position. When the temple 820 rotates relative to the frame 810 around the second rotating shaft 41 from the initial position to the first position, the first sliding shaft 421 located in the arc groove 511 moves to the limiting point of the arc groove 511 close to the second elastic portion 53. At this time, the second sliding shaft 422 is located in the first limiting groove 522, and the third sliding shaft 423 is located at the second limiting port 533. When the temple 820 rotates relative to the frame 810 around the second rotating shaft 41 from the initial position to the second position, the first sliding shaft 421 located in the arc groove 511 moves to the limiting point of the arc groove 511 close to the first elastic portion 52. At this time, the second sliding shaft 422 is located at the first limiting port 523, and the third sliding shaft 423 is located in the second limiting groove 532.

It can be understood that, as shown in FIG. 13, the temple 820 is located above the initial position in the first position, and the temple 820 is below the initial position in the second position.

In an embodiment, the second connecting member 4 includes a connecting plate 43 and a second rotating shaft 41 and a sliding shaft 42 protruding from the connecting plate 43. The second rotating shaft 41 is also provided with a fixing hole 411. The second connecting member 4 also includes a fixing member 44. One end of the fixing member 44 forms a limiting platform 441. The second rotating shaft 41 is rotatably provided in the second rotating hole 121 and the rotating cylinder 125 so that the connecting plate 43 abuts against the side of the bottom plate 12 facing away from the side plate 13. One end of the fixing member 44 is provided in the fixing hole 411 so that the limiting platform 441 movably abuts against the rotating cylinder 125.

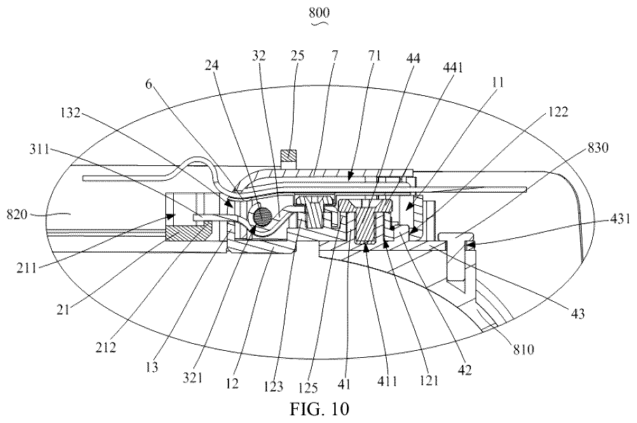

In this embodiment, as shown in FIG. 2, FIG. 6, and FIG. 10 to FIG. 12, the connecting plate 43 of the second connecting member 4 is configured to be provided with the second rotating shaft 41 and the sliding shaft 42. By providing a fixing hole 411 in the second rotating shaft 41, when the second rotating shaft 41 is rotatably provided in the second rotating hole 121 and the sliding shaft 42 is provided in the sliding hole 122, the connecting plate 43 is limited and abutted against the bottom plate 12 of the rotating base 1. By providing one end of the fixing member 44 in the fixing hole 411, the limiting platform 441 movably abuts against the rotating cylinder 125 of the rotating base 1, thus realizing the installation and rotational connection of the second connecting member 4 and the rotating base 1.

It can be understood that in order to connect the second connecting member 4 of the hinge module 100 to the frame 810, the second connecting member 4 is further provided with a fastening hole 431. The fastener 830 passes through the fastening hole 431 and is connected to the frame 810.

In this embodiment, as shown in FIG. 2, FIG. 6, and FIG. 10 to FIG. 12, the connecting plate 43 of the second connecting member 4 is further provided with a fastening hole 431. The connecting plate 43 is provided with the fastening hole 431 through the fastener 830 and connected to the frame 810. It can be understood that the fastener 830 can be a screw or a pin.

In order to facilitate the installation, fixing and concealment of the hinge module 100, the frame 810 is further provided with a groove corresponding to the connecting plate 43 of the second connecting member 4. Thus, when the second connecting member 4 is connected to the frame 810, the connecting plate 43 is accommodated and limited in the groove, which is not limited here.

In an embodiment, the first elastic member 3 includes a main body 31 and a damping arm 32. One end of the main body 31 is accommodated in the accommodating groove 11, and the other end of the main body 31 forms an outward flipping spring sheet 311. The outward flipping elastic member 311 elastically abuts against the first connecting member 2. The main body 31 is further provided with an elastic through hole 312. One end of the damping arm 32 is connected to the inner wall of the elastic through hole 312, and the other end of the damping arm 32 extends along the elastic through hole 312 and bends to form a damping groove 321.

In this embodiment, the first elastic member 3 can be selected as a spring sheet or an elastic plate structure. The material of the first elastic member 3 can be stainless steel or carbon fiber. In an embodiment, when the material of the first elastic member 3 is stainless steel, the stainless steel material includes one of titanium alloy, nickel-titanium alloy, and beryllium copper. It can be understood that by providing an elastic through hole 312 in the main body 31 of the first elastic member 3, one end of the damping arm 32 is connected to the inner wall of the elastic through hole 312, and the other end of the damping arm 32 extends along the elastic through hole 312 and is bent to form a damping groove 321, thereby improving the elastic performance of the damping arm 32.

It can be understood that the main body 31 of the first elastic member 3 and the damping arm 32 are integrally formed, which improves the connection stability and structural strength between the damping arm 32 and the main body 31. In this embodiment, the inner wall of the damping groove 321 abuts against the outer wall of the first rotating shaft 24, so that frictional damping is formed when the first rotating shaft 24 rotates relative to the damping groove 321, so that the movement of the first rotating shaft 24 has a damped folding feel of the hinge movement, thereby realizing the folding of the temple 820 and making the folding have a damped feel.

In an embodiment, the distance from the end of the damping arm 32 bent to form the damping groove 321 to the damping arm 32 is defined as the opening width of the damping groove 321, and the opening width is less than or equal to ⅓ of the circumference of the first rotating shaft 24. It can be understood that by providing the damping groove 321 of the damping arm 32 to a semi-open structure, that is, the damping groove 321 partially wraps around the outer wall of the first rotating shaft 24, it is convenient to mount the first rotating shaft 24, and it also ensures that the damping groove 321 has good damping effect and damping feel.

It can be understood that the cross section of the first rotating shaft 24 in the direction perpendicular to the axial direction of the first rotating shaft 24 may be circular, the cross section of the damping groove 321 in the direction perpendicular to the axial direction of the first rotating shaft 24 may be arc, and the circumference of the arc inner wall of the damping groove is greater than or equal to ⅔ of the circumference of the first rotating shaft 24.

In this embodiment, an outward flipping spring sheet 311 is formed at one end of the main body 31, and the outward flipping spring sheet 311 elastically abuts against the first connecting member 2. Thus, when the glasses 800 is in the outward flipping state, the temple 820 drives the first connecting member 2 to rotate outward relative to the frame 810 around the first rotating shaft 24, and the first connecting member 2 drives the outward flipping spring sheet 311 of the first elastic member 3 to elastically deform, thereby generating a torque for the first connecting member 2 to rotate inward, thus providing a holding force. When the outward flipping force is removed, the elastically deformed outward flipping spring sheet 311 will push the first connecting member 2 to drive the temple 820 back to the original state of the outward flipping spring sheet 311, thereby realizing that after the outward flipping force is removed, the temple 820 can automatically spring back to the original position.

It can be understood that the first elastic member 3 can be selected as a spring sheet structure, which has good elasticity. In an embodiment, the elastic modulus of the first elastic member 3 is 50 Gpa to 400 Gpa, that is, the elastic modulus of the first elastic member 3 is 50 Gpa, 100 Gpa, 150 Gpa, 200 Gpa, 250 Gpa, 300 Gpa, 350 Gpa, 400 Gpa, etc., which is not limited here.

In order to facilitate the outward flipping spring sheet 311 in providing clamping force when the first connecting member 2 is outward flipping and automatic rebound after the eversion force is removed. In this embodiment, the length of the outward flipping spring sheet 311 can be selected from 5 mm to 30 mm. In an embodiment, the length of the outward flipping spring sheet 311 can be 5 mm, 10 mm, 15 mm, 20 mm, 25 mm, 30 mm, etc., and is not limited here. In an embodiment, the thickness of the outward flipping spring sheet 311 can be 0.3 mm to 1.5 mm, that is, the thickness of the outward flipping spring sheet 311 can be 0.3 mm, 0.5 mm, 0.8 mm, 1 mm, 1.3 mm, 1.5 mm, etc., and is not limited here. It can be understood that this setting can ensure that the first elastic member 3 has good elasticity.

In an embodiment, the bottom wall of the accommodating groove 11 is protrudingly provided with a fixing post 123. The fixing post 123 is located between the first rotating hole 131 and the second rotating hole 121, and the main body 31 is fixed to the fixing post 123 by the fastener.

In this embodiment, as shown in FIG. 2, FIG. 3, and FIG. 10 to FIG. 12, by providing a fixing post 123 in the accommodating groove 11 of the rotating base 1, and providing a through hole at the first elastic member 3 corresponding to the fixing post 123, fasteners are then screwed or inserted through the through hole to the fixing post 123, thus fixing the first elastic member 3 to the rotating base 1. At the same time, the fixing post 123 provides support for the first elastic member 3. In an embodiment, the fixing post 123 is located between the first rotating hole 131 and the second rotating hole 121.

It can be understood that, the fixing post 123 may be a threaded post, and the fastener may be a screw or pin, etc.

In an embodiment, one of the clamping groove wall of the accommodating groove 11 and the main body 31 is provided with a clamping protrusion 313, the other of the accommodating groove 11 and the main body 31 is provided with a clamping groove 124, and the clamping protrusion 313 is provided in the clamping groove 124.

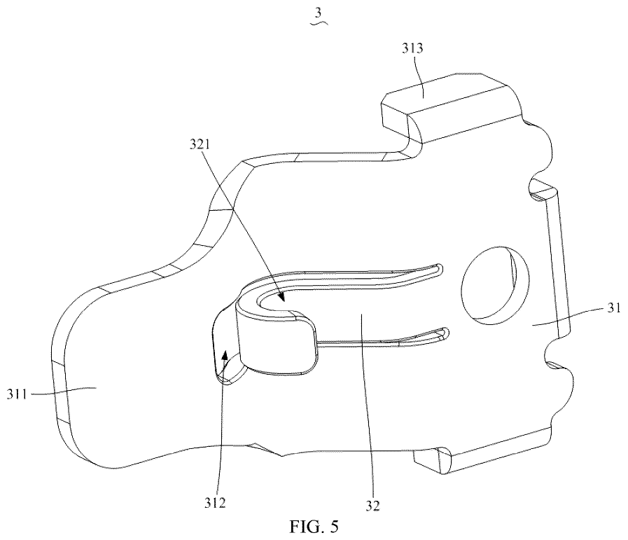

In this embodiment, as shown in FIG. 2, FIG. 3, FIG. 5, FIG. 11, and FIG. 12, one of the rotating base 1 and the first elastic member 3 is provided with a clamping protrusion 313, and the other of the rotating base 1 and the first elastic member 3 is provided with a clamping groove 124. The clamping protrusion 313 is provided in the clamping groove 124, thereby further realizing the positioning, installation, and clamping of the first elastic member 3. It can be understood that the clamping protrusion 313 is provided in the first elastic member 3, and the clamping groove 124 is provided in the rotating base 1. Thus, with the clamping protrusion 313 provided in the clamping groove 124, both positioning and clamping can be achieved, and the main body 31 of the first elastic member 3 can be supported by the clamping protrusion 313 to ensure the deformation capability of the first elastic member 3.

In an embodiment, two first rotating holes 131 are provided, and the two first rotating holes 131 are coaxially provided and located on opposite sides of the accommodating groove 11. The first connecting member 2 includes a first connecting portion 21 and two rotating arms 22 provided at both ends of the first connecting portion 21, the two rotating arms 22 enclose with the first connecting portion 21 to form an avoidance slot 23, and each rotating arm 22 is provided with a mounting hole 221 at one end away from the first connecting portion 21. The first rotating shaft 24 sequentially passes through the mounting hole 221, the first rotating hole 131 and the damping groove 321, and both ends of the first rotating shaft 24 are fixed in the two mounting holes 221 so that portion of the rotating base 1 is accommodated in the avoidance slot 23, and the end of the first elastic member 3 away from the second rotating hole 121 elastically abuts against the first connecting portion 21.

In this embodiment, as shown in FIG. 1 to FIG. 3 and FIG. 11 to FIG. 12, the bottom plate 12 of the rotating base 1 may be rectangular, and the portions of the side plate 13 of the rotating base 1 located on the two long axis sides of the bottom plate 12 are provided parallel and opposite to each other. That is, each side plate 13 located on the two long axis sides of the bottom plate 12 is provided with a first rotating hole 131, and the two first rotating holes 131 are coaxially provided. In an embodiment, the line connecting the two first rotating holes 131 is perpendicular to the axial direction of the second rotating shaft 41.

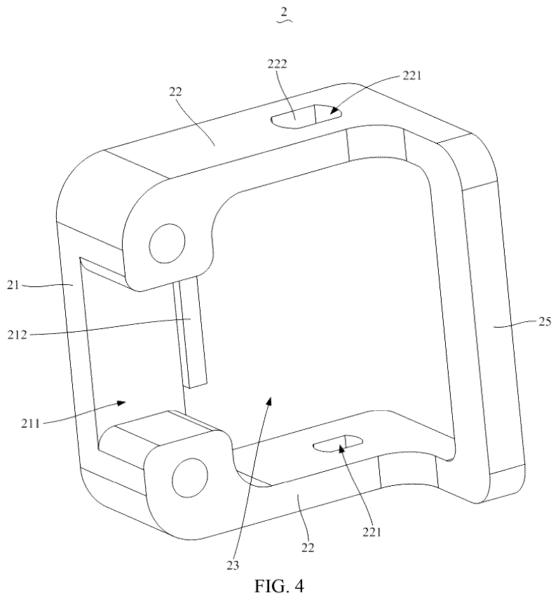

It can be understood that, as shown in FIG. 1, FIG. 2, and FIG. 4, by providing the first connecting member 2 as a first connecting portion 21 and two rotating arms 22 located at both ends of the first connecting portion 21, the two rotating arms 22 enclose with the first connecting portion 21 to form a U-shaped avoidance slot 23, and a mounting hole 221 is provided at the end of the rotating arm 22 away from the first connecting portion 21. Thus, the first connecting portion 21 of the first connecting member 2 is connected to the temple 820, the first rotating shaft 24 sequentially passes through the mounting hole 221, the first rotating hole 131, and the damping groove 321, and both ends of the first rotating shaft 24 is fixed in the two mounting holes 221, allowing portion of the rotating base 1 to be provided in the avoidance slot 23, thereby achieving a rotational connection between the first connecting member 2 and the rotating base 1. In an embodiment, the first connecting member 2 and the temple 820 can be connected and fixed by welding, bonding, or using screws, pins, etc.

In an embodiment, the first rotating shaft 24 includes a rotating shaft portion 241 and a mounting portion 242 connected to both ends of the rotating shaft portion 241. The rotating shaft portion 241 sequentially passes through the first rotating hole 131 and the damping groove 321. Each mounting portion 242 is provided in a mounting hole 221. The mounting hole 221 is provided with at least one mounting plane 222. The mounting portion 242 is provided with a limiting plane 243 that cooperates with the mounting plane 222.

In this embodiment, as shown in FIG. 1, FIG. 2 and FIG. 4, by providing limiting planes 243 at both ends of the first rotating shaft 24 and providing a mounting plane 222 in the mounting hole 221, when the mounting portion 242 of the first rotating shaft 24 is provided in the mounting hole 221, the limiting planes 243 and the mounting plane 222 are used for limiting cooperation, thereby ensuring that the first connecting member 2 rotates synchronously with the first rotating shaft 24, that is, the first connecting member 2 drives the first rotating shaft 24 to rotate relative to the first rotating hole 131 and the damping groove 321.

It can be understood that the cross-section of the rotating shaft portion 241 of the first rotating shaft 24 may be circular. In an embodiment, the mounting hole 221 is a polygonal hole, and the first rotating hole 131 is a circular hole. In this embodiment, the first rotating shaft 24 is a pin with a different cross-section, and both ends of the first rotating shaft 24 are flat shafts, configured to fix together with the mounting hole 221 of the first connecting member 2, for example, by interference fit, spot welding, bonding, etc. The first rotating shaft 24 and the first rotating hole 131 of the rotating base 1 are fitted with a rotatable circular hole cylinder to form a rotation center for mutual rotation between the two.

In an embodiment, as shown in FIG. 2 and FIG. 4, the first connecting portion 21 is recessed to form an position avoiding groove 211 communicating with the avoidance slot 23. A support platform 212 is provided at the side of the position avoiding groove 211 adjacent to the avoidance slot 23. The end of the first elastic member 3 away from the second rotating hole 121 extends into the position avoiding groove 211 and is elastically supported on the support platform 212.

It can be understood that, by providing a position avoiding groove 211 in the first connecting portion 21 of the first connecting member 2, on the one hand, the position avoiding groove 211 provides avoidance space for the outward flipping spring sheet 311 of the first elastic member 3, and on the other hand, the position avoiding groove 211 can also provide a limiting space for the outward flipping spring sheet 311.

In an embodiment, the first connecting member 2 further includes a limiting portion 25, the two ends of the limiting portion 25, are respectively connected to the ends of the two rotating arms 22 away from the first connecting portion 21, and the limiting portion 25 is located on the side of the first elastic member 3 facing away from the accommodating groove 11.

In this embodiment, as shown in FIG. 1, FIG. 2 and FIG. 4, by providing a limiting portion 25 at the first connecting member 2, the two ends of the limiting portion 25 are respectively connected to the ends of the two rotating arms 22 away from the first connecting portion 21, so that the limiting portion 25 can achieve the limiting function when the first connecting member 2 rotates around the first rotating shaft 24 relative to the rotating base 1.

It can be understood that, the hinge module 100 has a folded state, an open state, and an outward flipping state where the first connecting member 2 rotates relative to the rotating base 1 around the first rotating shaft 24. In the folded state, the rotating arm 22 is perpendicular to the bottom plate 12, the first connecting portion 21 is away from the outward flipping spring sheet 311, and the limiting portion 25 is close to the outward flipping spring sheet 311. In the open state, the rotating arm 22 is parallel to the bottom plate 12, and the outward flipping spring sheet 311 abuts against the support platform 212, and the limiting portion 25 is located on the side of the side plate 13 away from the bottom plate 12. In the outward flipping state, the rotating arm 22 is provided at an angle to the bottom plate 12, the first connecting portion 21 causes the outward flipping spring sheet 311 to deform, and the limiting portion 25 moves towards the side plate 13 in a direction away from the outward flipping spring sheet 311.

It should be noted that when the hinge module 100 is applied to the glasses 800, the glasses 800 has a folded state, an open state, and an outward flipping state in which the first connecting member 2 drives the temple 820 to rotate around the first rotating shaft 24 relative to the rotating base 1 and the frame 810. In the folded state, the temple 820 is close to the frame 810, and the first connecting portion 21 is away from the first elastic member 3, while the limiting portion 25 is close to the outward flipping spring sheet 311. In the open state, the temple 820 is away from the frame 810 and is perpendicular to the frame 810. The first connecting portion 21 abuts against the outward flipping spring sheet 311, and the limiting portion 25 is away from the outward flipping spring sheet 311. In the outward flipping state, the temple 820 is provided at an obtuse angle to the frame 810, and the first connecting portion 21 causes the outward flipping spring sheet 311 to deform.

It can be understood that when the glasses 800 is in the folded state, the rotating arm 22 of the first connecting member 2 is approximately perpendicular to the bottom plate 12 of the rotating base 1, and the limiting portion 25 is close to the outward flipping spring sheet 311. When the glasses 800 is in the open state, the limiting portion 25 is located on the side of the side plate 13 of the rotating base 1 away from the bottom plate 12. When the glasses 800 is in the outward flipping state, the first connecting portion 21 of the first connecting member 2 causes the outward flipping spring sheet 311 to deform to the maximum deformation amount, the limiting portion 25 abuts against the side plate 13 of the rotating base 1 to prevent the temples 820 from excessively folding outward.

In an embodiment, the hinge module 100 further includes a protective plate 6 and a housing 7. The protective plate 6 is provided in the accommodating groove 11 and connected to the side of the first elastic member 3 facing away from the bottom wall of the accommodating groove 11. The protective plate 6 is provided with a wire passage groove 61 on the side facing away from the first elastic member 3. The housing 7 covers the notch of the accommodating groove 11 and cooperates with the wire passage groove 61 to form a wiring passage 71.

In this embodiment, as shown in FIG. 1, FIG. 2, FIG. 9, and FIG. 10, by providing the protective plate 6 and the housing 7, the protective plate 6 provides wiring or mounting space for the flexible circuit board of the optical system connecting the glasses 800. It can be understood that the protective plate 6 is provided in the accommodating groove 11, and the protective plate 6 and the first elastic member 3 are sequentially fixed to the fixing post 123 of the rotating base 1 using fasteners, thereby achieving the installation and fixation of the protective plate 6.

It can be understood that by providing the wire passage groove 61 on the side of the protective plate 6 facing away from the first elastic member 3, it is convenient to use the wire passage groove 61 to realize the installation of wires or flexible circuit boards. In this embodiment, by providing the housing 7, on the one hand, it is to protect the cable or flexible circuit board in the wire passage groove 61, and on the other hand, it is to improve the aesthetic appearance.

In an embodiment, the housing 7 is detachably provided at the notch of the accommodating groove 11 and cooperates with the wire passing groove 61 to form a wiring passage 71. It can be understood that by adopting a detachable connection between the housing 7 and the rotating base 1, the housing 7 can be easily removed at any time, making it convenient to mount cables or flexible circuit boards in the wire passing groove 61.

The hinge module 100 of the present application mainly involves two degrees of freedom of rotation axes. When the hinge module 100 is applied to glasses 800, the hinge module 100 includes a first rotating shaft 24 (axis A) as shown in FIG. 10 and a second rotating shaft 41 (axis B) as shown in FIG. 11 and FIG. 12, and axis A is configured to realize the folding, unfolding, and outward flipping functions of the temple 820. It can be understood that the folding function is configured to fold and store the temple 820, and the outward flipping function is configured to meet the comfort adjustment needs of users with different head widths. Axis B is configured to realize the lateral adjustment function of the temple 820, and axis B has three-gear adjustment function to meet the comfort adjustment needs of users with different head shapes and nose-ear ratios.

It can be understood that, referring to FIG. 1 and FIG. 2, FIG. 1 and FIG. 2 are schematic diagrams of the hinge module 100. The first connecting member 2, the rotating base 1, and the first elastic member 3 can be pre-assembled together as an integral module through the first rotating shaft 24. Then, the second connecting member 4, the second elastic member 5, the protective plate 6, and the housing 7 are assembled sequentially.

In this embodiment, the first connecting member 2, the rotating base 1, and the first elastic member 3 are assembled into a modular structure through the first rotating shaft 24. The hinge module 100 passes through the second rotating hole 121 of the rotating base 1 through the second rotating shaft 41 of the second connecting member 4 and is fixedly connected to the fixing member 44. The second elastic member 5 is elastically provided between the rotating cylinder 125 and the sliding shaft 42 of the rotating base 1. The first connecting member 2 is rigidly connected to the temple 820 by means of screws, adhesives, or other fixing methods. The second connecting member 4 is connected to the frame 810. The hinge module 100 is configured to realize the axis A movement of the temple 820 and provide the outward flipping force. After the hinge module 100 is assembled with the frame 810 through the cooperation of the second connecting member 4 and the second elastic member 5, it is configured to realize the lateral movement of the temple 820 and provide the force (i.e., axis B). As shown in FIG. 10 and FIG. 14, axis A is configured to realize folding and outward flipping; as shown in FIG. 11, FIG. 12 and FIG. 13, axis B is configured to realize the side axis adjustment function of the temple 820.

It can be understood that the hinge connection between the temple 820 and the frame 810 of the glasses 800 achieve a damping feel during both outward flipping and folding. When the temple 820 is rotated, it will drive the first connecting member 2 to rotate. The rotating base 1 is fixed to the frame 810 through the second connecting member 4. The first elastic member 3 is a metal plate with good elasticity. The outward flipping spring sheet 311 on the first elastic member 3 is configured to provide clamping force when folding outward and automatic rebound after the outward folding force is removed. The damping groove 321 of the damping arm 32 of the first elastic member 3 is configured to provide damping force during the rotation of the temple 820, so that there is a certain damping feeling during the movement. The first rotating shaft 24 is a pin with different cross sections, both ends of the first rotating shaft 24 are flat shafts, configured to rigidly fix it together with the first connecting member 2, for example, by interference fit, spot welding, bonding, etc. The fixation of the first rotating shaft 24 and the rotating base 1 is fixed through a rotatable circular hole cylinder fit to form a central rotation axis A, which is used for mutual rotation between the two. Therefore, when the temple 820 is folded, the temple 820 will drive the first connecting member 2 inward, and form a folding motion with the rotating base 1 through the first rotating shaft 24. The first rotating shaft 24 and the first connecting member 2 rotate together. The rotation of the first rotating shaft 24 will form frictional damping with the damping groove 321 of the first elastic member 3, so that the hinge movement has a damped folding feel during the movement, thereby realizing the folding of the temple 820 and making the folding have a damped feel.

When the temple 820 is flipped outward, it accommodates users with different head widths. The temple 820 will cause the first connecting member 2 to rotate outwards. The rotating first connecting member 2 will cause the outward flipping spring sheet 311 on the first elastic member 3 to deform elastically, thereby generating a torque that pushes the first connecting member 2 to rotate inward, thus providing a supporting force. When the outward flipping force is removed, the elastically deformed outward flipping spring sheet 311 will push the first connecting member 2 to drive the temple 820 back to the original state of the spring sheet, thereby realizing that after the outward flipping force is removed, the temple 820 can automatically spring back to the original position.

It can be understood that the temple 820 and frame 810 of the glasses 800 can also achieve a lateral axis adjustment structure to adjust the angle between the temples 820 and frame 810, accommodating users with different head shapes. The hinge module 100 first passes through the positioning groove of the frame 810, and the second connecting member 4 is positioned and restricted by the fastener 830 and fixed to the corresponding groove of the frame 810. Since the second rotating shaft 41 of the second connecting member 4 in the hinge module 100 and the second rotating hole 121 in the rotating base 1 cooperate to form a rotating axis, constituting a lateral rotation center axis B. When the temples 820 are rotated along the up and down direction, the temple 820 drive the hinge module 100 to rotate along the rotation center axis B. When the first sliding shaft 421 is matched with the arc groove 511, the cylinder of the first sliding shaft 421 makes interference contact with the elastic groove of the arc groove 511, maintaining the temples 820 in the initial position. After the temple 820 is rotated downwards, the cylinder of the first sliding shaft 421 disengages from the arc groove 511. When it continues to rotate to a predetermined angle, such as 10 degrees, the cylinder of the third sliding shaft 423 will elastically press into the groove of the second limiting groove 532. The second limiting groove 532 restricts the third sliding shaft 423, and the temple 820 stays in the second position state of rotating downwards by 10 degrees, thereby completing the lateral downward posture adjustment of the temple 820. Similarly, the second sliding shaft 422 and the first limiting groove 522 complete the upward angle adjustment, so that the temple 820 stays in the first position state of rotating upwards, completing the angle adjustment between the temple 820 and the frame 810. The schematic diagram after rotation is shown in FIG. 12 and FIG. 13.

The sliding shaft 42 can slide within the corresponding sliding hole 122 on the rotating base 1, simultaneously enhancing the resistance to deformation when the temple 820 is twisted, and preventing over-bending failure. The second elastic member 5 can be made of stainless steel, including materials such as titanium alloy, nickel-titanium alloy, and beryllium copper; alternatively, the second elastic member 5 can be made of composite materials such as carbon fiber. In an embodiment, the elastic modulus of the second elastic member 5 is between 50 GPa and 400 GPa. It can be understood that the shape of the second elastic member 5 can be as shown in FIG. 7, or other similar shapes. The number of fasteners 830 can be one or more, and there is no limitation here.

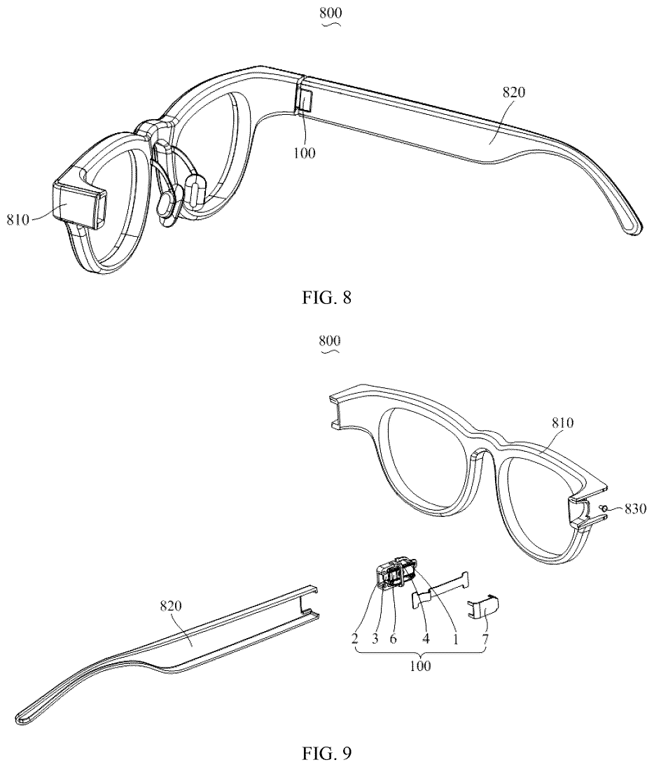

As shown in FIG. 8 to FIG. 14, the present application also provides a pair of glasses 800, and the glasses 800 includes a frame 810, a temple 820 and the above hinge module 100. The specific structure of the hinge module 100 is according to the foregoing embodiments. Since this pair of glasses 800 adopts all the technical solutions of all the foregoing embodiments, it has at least all the beneficial effects brought about by the technical solutions of the foregoing embodiments, which will not be described in detail here.

It can be understood that the second connecting member 4 of the hinge module 100 is connected to the frame 810, and the first connecting member 2 of the hinge module 100 is connected to the temple 820. In this embodiment, the glasses 800 can be ordinary glasses such as myopia glasses, presbyopia glasses, astigmatism glasses, sun protection glasses, and decorative glasses. The glasses 800 can also be smart glasses, such as virtual reality (VR), augmented reality (AR), mixed reality (MR), and extended reality (XR) glasses, etc., without limitation.

It should be noted that the frame 810 of the glasses 800 has mounting holes corresponding to the user's two eyes. The two mounting holes can be configured to mount different lenses or intelligent optical systems, etc., which are not limited here. For the convenience of the user, the frame 810 also has a nose pad structure between the two mounting holes for abutting against the user's nose bridge, etc., which are not limited here.

In order to facilitate wearing the glasses 800, the frame 810 of the glasses 800 is typically rotatably connected to two symmetrically provided temples 820, allowing the user to wear the glasses through the nose pads of the frame 810 and the two temples 820. In other embodiments, the frame 810 can also be connected to a headband structure, so that the head-mounted structure enclose with the frame 810 to form a ring-shaped wearing space, etc. For smart glasses devices, because the optical system is mounted on the frame 810, the frame 810 is relatively heavy. Therefore, a head-mounted structure, a headband structure, or the like is designed to facilitate wearing and prevent the frame 810 from falling off due to its relatively heavy weight, which is not limited herein.

In this embodiment, the glasses 800 is described using the structure of a frame 810 and two temples 820 as an example. To facilitate the connection between the frame 810 and the two temples 820, connecting portions or mounting portions are provided at both ends of the frame 810. It can be understood that the two connecting portions or mounting portions at both ends of the frame 810 are provided at a certain angle to the plane containing the two mounting holes of the frame 810, that is, the two connecting portions or mounting portions are generally formed by extending from both ends of the frame 810 toward the user's ears.

It should be noted that, in order to avoid the two connecting portions or mounting portions at both ends of the frame 810 affecting the user's wearing experience, the extension length of the two connecting portions or mounting portions is relatively short. The extension length of the two connecting portions or mounting portions can refer to existing technology and is not limited here.

In this embodiment, as shown in FIG. 8 and FIG. 9, the two connecting portions or mounting portions at both ends of the frame 810 are respectively provided with mounting grooves. The mounting grooves are configured to accommodate and mount at least portion of the hinge module 100, and the hinge module 100 is configured to be connected to the temple 820, so that the temple 820 is rotatably connected to the connecting portion or mounting portion at both ends of the frame 810 through the hinge module 100.

In this embodiment, the glasses 800 can also be an AR device. The glasses 800 also includes an optical system connected to the frame 810 of the glasses 800. It can be understood that the glasses 800 includes a flexible circuit board, and one end of the flexible circuit board passes through the wiring passage 71 and is electrically connected to the optical system. The temple 820 of the glasses 800 is provided with a mounting cavity or other structure for mounting a power supply. The other end of the flexible circuit board is guided through the wiring passage 71 to the mounting cavity of the temple 820 and electrically connected to the power supply or other components. This is not limited here.

It can be understood that glasses 800 can be virtual reality (VR) glasses, augmented reality (AR) glasses, mixed reality (MR) glasses, and extended reality (XR) glasses, and no specific limitation is made here.

Although the above embodiments of the present application have been described, those skilled in the art, upon learning the basic inventive concept, can make other changes and modifications to these embodiments. Therefore, the appended claims are intended to be interpreted as including the above embodiments as well as all changes and modifications falling within the scope of the present application.

The above description is merely an embodiment of the present application and does not limit the patent scope of the present application. Any equivalent structural transformations made based on the content of the present application's specification and drawings under the concept of the present application, or direct/indirect applications in other related technical fields, are included within the patent protection scope of the present application.

What is claimed is:

1. A hinge module, comprising:
a rotating base provided with an accommodating groove and a first rotating hole, a second rotating hole and a sliding hole communicating with the accommodating groove;
a first connecting member rotatably connected to the rotating base through a first rotating shaft matching with a hole shaft of the first rotating hole;
a first elastic member, wherein an end of the first elastic member is accommodated in the accommodating groove and is provided with a damping groove rotatably abutting against the first rotating shaft, and the other end of the first elastic member elastically abuts against the first connecting member;
a second connecting member provided with a second rotating shaft and a sliding shaft provided at intervals, wherein the second rotating shaft is rotatably provided in the second rotating hole to rotatably connect the second connecting member to the rotating base, and the sliding shaft movably provided in the sliding hole; and
a second elastic member accommodated in the accommodating groove and elastically abutting against the sliding shaft;
wherein, the axial direction of the first rotating shaft is provided at an angle to the axial direction of the second rotating shaft.

2. The hinge module according to claim 1, wherein:
the rotating base comprises a bottom plate and a side plate, the side plate is provided at a periphery edge of the bottom plate and encloses with the bottom plate to form the accommodating groove, the side plate is provided with the first rotating hole, and the bottom plate is provided with the second rotating hole and the sliding hole; and
the side plate is provided with an avoidance notch communicating with the accommodating groove on a side away from the second rotating hole, and an end of the first elastic member away from the second rotating hole passes through the avoidance notch and elastically abuts against the first connecting member.

3. The hinge module according to claim 2, wherein the bottom plate is protrudently provided with a rotating cylinder around the second rotating hole, the second rotating shaft rotatably passes through the second rotating hole and rotatably abuts against an inner wall of the rotating cylinder, and the second elastic member is elastically provided between the rotating cylinder and the sliding shaft.

4. The hinge module according to claim 3, wherein:
a plurality of sliding holes are provided, and the plurality of sliding holes are provided at intervals around the second rotating hole; and
the second connecting member is provided with a plurality of sliding shafts, the plurality of sliding shafts are provided at intervals around the second rotating shaft, and each of the plurality of sliding shafts is movably provided in one of the plurality of sliding holes and elastically abuts against the second elastic member.

5. The hinge module according to claim 4, wherein:
the second elastic member comprises an arc portion and a first elastic portion and a second elastic portion connected to both ends of the arc portion, an end of the first elastic portion away from the arc portion is bent to form a first bending portion, and the end of the second elastic portion away from the arc portion is bent to form a second bending portion;
the plurality of sliding shafts comprises a first sliding shaft corresponding to the arc portion, a second sliding shaft corresponding to the first bending portion, and a third sliding shaft corresponding to the second bending portion; and
the arc portion slidably abuts against an outer wall of the first sliding shaft and elastically abuts against an outer wall of the rotating cylinder, the second sliding shaft movably abuts against the first bending portion, and the third sliding shaft movably abuts against the second bending portion.

6. The hinge module according to claim 5, wherein:
an arc groove is formed on a side of the arc portion facing away from the rotating cylinder, the first bending portion forms a first limiting groove and a first limiting port communicated with the first limiting groove, and the second bending portion forms a second limiting groove and a second limiting port communicated with the second limiting groove;
the hinge module has an initial position, a first position, and a second position where the rotating base drives the first connecting member to rotate relative to the second connecting member around the second rotating shaft;
in the initial position, the first sliding shaft is located within the arc groove, and the second sliding shaft is located at a communicating position of the first limiting groove and the first limiting port, and the third sliding shaft is located at a communicating position of the second limiting groove and the second limiting port;
in the first position, the first sliding shaft slides to a connecting position between the arc portion and the first elastic portion, and the second sliding shaft is located within the first limiting groove, and the third sliding shaft is located at the second limiting port; and
in the second position, the first sliding shaft slides to a connecting position between the arc portion and the second elastic portion, the second sliding shaft is located at the first limiting port, and the third sliding shaft is located within the second limiting groove.

7. The hinge module according to claim 5, wherein:
an axial direction of the second rotating hole is perpendicular to an axial direction of the first rotating hole;
the axial direction of the second rotating hole is parallel to an axial direction of the sliding hole;
an outer wall of the rotating cylinder is provided with a limiting protrusion located between two adjacent sliding holes, the bottom plate is provided with a fixing protrusion corresponding to the limiting protrusion, the limiting protrusion abuts against the fixing protrusion and cooperate with the bottom plate to form a limiting space, and the first elastic portion and the second elastic portion are respectively provided in the limiting space;
the sliding hole is provided in an arc shape with a center of the second rotating hole as a center; and
the second connecting member comprises a connecting plate, a second rotating shaft and the sliding shaft protruding from the connecting plate, and the second rotating shaft is further provided with a fixing hole; the second connecting member further comprises a fixing member, one end of the fixing member forms a limiting platform, and the second rotating shaft is rotatably provided in the second rotating hole and the rotating cylinder, so that the connecting plate abuts against a side of the bottom plate facing away from the side plate; and an end of the fixing member is provided in the fixing hole, so that the limiting platform movably abuts against the rotating cylinder.

8. The hinge module according to claim 1, wherein:
the first elastic member comprises a main body and a damping arm, an end of the main body is accommodated in the accommodating groove, the other end of the main body forms an outward flipping spring sheet, and the outward flipping spring sheet elastically abuts against the first connecting member; and
the main body is further provided with an elastic through hole, an end of the damping arm is connected to an inner wall of the elastic through hole, and the other end of the damping arm extends along the elastic through hole and bends to form the damping groove.

9. The hinge module according to claim 8, wherein:
the first elastic member is made of stainless steel or carbon fiber, and the stainless steel comprises one of titanium alloy, nickel-titanium alloy, and beryllium copper;
an elastic module of the first elastic member is 50 GPa to 400 GPa;
a length of the outward flipping spring sheet is 5 mm to 30 mm;
a thickness of the outward flipping spring sheet is 0.3 mm to 1.5 mm;
a distance from an end of the damping arm bent to form the damping groove to the damping arm is provided as an opening width of the damping groove, and the opening width is less than or equal to ⅓ of a circumference of the first rotating shaft;
a fixing post protrudes from a bottom wall of the accommodating groove, the fixing post is located between the first rotating hole and the second rotating hole, and the main body is fixed to the fixing post by a fastener; and
one of the groove wall of the accommodating groove and the main body is provided with a clamping protrusion, the other of the groove wall of the accommodating groove is provided with a clamping groove, and the clamping protrusion is provided in the clamping groove.

10. The hinge module according to claim 1, wherein:
two first rotating holes are provided, and the two first rotating holes are coaxial and located on opposite sides of the accommodating groove;
the first connecting member comprises a first connecting portion and two rotating arms provided at both ends of the first connecting portion, the two rotating arms encloses with the first connecting portion to form an avoidance slot, and each of the rotating arms is provided with a mounting hole at an end away from the first connecting portion; and
the first rotating shaft sequentially passes through the mounting hole, the first rotating hole, and the damping groove, and both ends of the first rotating shaft are fixed in the two mounting holes, so that a portion of the rotating base is accommodated in the avoidance slot, and an end of the first elastic member away from the second rotating hole elastically abuts against the first connecting portion.

11. The hinge module according to claim 10, wherein:
the first rotating shaft comprises a rotating shaft portion and mounting portions connected to both ends of the rotating shaft portion, the rotating shaft portion sequentially passes through the first rotating hole and the damping groove, each of the mounting portions is provided in a mounting hole, the mounting hole is provided with at least one mounting plane, and the mounting portion is provided with a limiting plane matching with the mounting plane;
the mounting hole is a polygonal hole, and the first rotating hole is a circular hole;
the first connecting portion is recessed to form a position avoiding groove communicating with the avoidance slot, a support platform protrudes from a side of the position avoiding groove adjacent to the avoidance slot, and an end of the first elastic member away from the second rotating hole extends into the position avoiding groove and is elastically supported on the support platform; and
the first connecting member further comprises a limiting portion, both ends of the limiting portion are respectively connected to an end of the two rotating arms away from the first connecting portion, and the limiting portion is located on a side of the first elastic member away from the accommodating groove.

12. The hinge module according to claim 1, further comprising:
a protective plate; and
a housing,
wherein the protective plate is accommodated in the accommodating groove and connected to a side of the first elastic member facing away from a bottom wall of the accommodating groove; and
a side of the protective plate facing away from the first elastic member is provided with a wire passage groove, and the housing covers an opening of the accommodating groove and cooperates with the wire passing groove to form a wire passage.

13. Glasses, comprising:
a frame;
a temple; and
the hinge module according to claim 1,
wherein the second connecting member of the hinge module is connected to the frame, and the first connecting member of the hinge module is connected to the temple.
